(19) United States
(12) Patent Application Publication
(10) Pub. No.: US 2003/0220114 A1
(43) Pub. Date: Nov. 27, 2003

(54) Consensual data delivery through beacons

(75) Inventors: Hubert Langensteiner, Mandelieu (FR); Paul J. Rankin, Horley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/153,262

(22) Filed: May 22, 2002

(51) Int. Cl. H04M 3/00; H04Q 7/20

(52) U.S. Cl. 455/450; 455/420

(57) ABSTRACT

A communications system comprises first (12) and second (14) beacon devices capable of wireless message transmission and at least one portable device (10) capable of receiving such message transmissions. The first beacon is arranged to broadcast a series of inquiry messages (INQ) over a first broadcast range (B.1) and according to a first communications protocol, such as Bluetooth. The portable device (10) detects such inquiry messages and replies with an identifier for the portable device. The first beacon (12) then transmits the received identifier to the second beacon (14), with the second beacon (14) and portable device (10) configured to perform a service interaction when the portable device (10) is within a respective second broadcast range (B.2) of the second beacon (14) and when triggered by the second beacon receiving the portable device identifier. At least one of the first (B.1) and second (B.2) broadcast ranges is relatively short, such as to permit interaction only when the user places the portable device (10) within the respective broadcast range.

The present invention relates to services offered to users of electronic equipment, especially but not exclusively to users of mobile communications devices such as portable telephones and suitably equipped PDA's (personal digital assistants). The invention further relates to a method and apparatus for delivery of such services.

Recent years have seen a great increase in subscribers world-wide to mobile telephone networks and, through advances in technology and the addition of functionalities, cellular telephones have become personal, trusted devices. A result of this is that a mobile information society is developing, with personalised and localised services becoming increasingly more important. Such “Context-Aware” (CA) mobile telephones are used with low power, short range base stations in places like shopping malls to provide location-specific information. This information might include local maps, information on nearby shops and restaurants and so on. The user's CA terminal may be equipped to filter the information received according to pre-stored user preferences and the user is only alerted if an item of data of particular interest has been received.

An existing methodology for implementing a radio beacon is to perform a two-step connection process, commencing with the discovery of devices followed by the actual transmission of the information using the same device. Bluetooth, one of the technologies/protocols available for building such systems, requires that the discovery phase is completed before a transmission can take place. When used in a dynamic mobile environment, the time this process takes can often be longer than the actual time the device is in range, causing the information not to reach the client.

A system which addresses this problem is described in the commonly assigned International patent application no. EP 01/06949 entitled ‘Local Data Delivery Through Beacons’ (Agents Ref. PHGB000112) filed with a priority date of Jun. 26, 2000 and unpublished at the priority date of the present application. The system provides a communications system comprising first and second beacon devices capable of wireless message transmission and at least one portable device capable of receiving such message transmissions, wherein said first beacon is arranged to broadcast a series of inquiry messages according to a first communications protocol, wherein said at least one portable device is arranged to detect such inquiry messages and reply with an identifier for the portable device, wherein said first beacon device is arranged to transmit a received identifier to said second beacon, and wherein said second beacon and portable device are configured to perform a service interaction when triggered by the second beacon receiving the portable device identifier.

Whilst the foregoing requires the portable device to go through both an inquiry and paging process, the ability of the first beacon to issue inquiry packets continuously makes the progress quicker. Furthermore, by having the second beacon handle all interactions, the first beacon does not have to pause operation to issue page messages, nor does it have to stop to allow interactive traffic. As a consequence, the portable device never has to wait for the first beacon to enter inquiry mode, which represents a significant saving.

Pushing (unsolicited delivery) of information over RF, IR or wide-area networks to mobile phone, tag or PDA devices requires prior consent and optionally further selection through profiling for it to be accepted by (and acceptable to) consumers. Unsolicited ‘junk’ alerts and offers will quickly be rejected.

The consent process itself, however, involving interaction with a central system, either beforehand or at the place where the push is to be delivered, and selection, plus a declaration of the user's handset identity, may entail prohibitive effort on the part of the casual user. Alternatively, filters may be activated by the user on their handset to block unwanted categories of pushed electronic offers. This may require user deliberations and effort to select the right personal filters for the place they are entering. An inefficient system may result which generates pushed offers and signals that are destined to be blocked by all of the users who are present in the locale.

It is accordingly an object of the present invention to provide a system for the delivery of data services via beacons whereby user selection of services for interacting with is accomplished in a relatively simple manner.

In accordance with the present invention this is provided a communications system comprising first and second beacon devices capable of wireless message transmission and at least one portable device capable of receiving such message transmissions, wherein said first beacon is arranged to broadcast a series of inquiry messages over a first broadcast range and according to a first communications protocol, wherein said at least one portable device is arranged to detect such inquiry messages when within said first broadcast range and reply with an identifier for the portable device, wherein said first beacon device is arranged to transmit a received identifier to said second beacon, wherein said second beacon and portable device are configured to perform a service interaction when the portable device is within a second broadcast range of the second beacon and when triggered by the second beacon receiving the portable device identifier, and wherein at least one of the first and second broadcast ranges is a relatively short broadcast range. The use of a relatively short range will mean that a user can choose to interact or not by simply approaching or staying away from a beacon: furthermore, the volume of competing beacon signals per area is reduced.

The relatively short broadcast range, which may be from a few centimetres to a few metres and may be adjustable, is suitably such as to require a user of the portable communications device to place the device deliberately relative to the position of the first and/or second beacon to enable interaction. One of the first and second broadcast ranges may be relatively short in comparison with the other to support consensual registration for longer-distance interaction, or blanket registration for subsequent shorter-range consensual interaction.

The exchange of inquiry message and identifier between the first beacon and portable device may include specification of one or more service interaction types, wherein plural forms of service interaction between the second beacon device and portable device are supported, and wherein one or more of these plural forms is inhibited in dependence on the said included specification. By permitting the user also to specify data services that they do or do not wish to receive, the volume of message transmission to the portable device may be further reduced.

The first beacon may be arranged, on receipt of an identifier for a portable device, to provide an indication to the user of the portable device that the device is registered for interaction with the second beacon: such an indication may comprise an audible, or visual signal presented to the user, or it may be in the form of a data signal sent to the portable device.

The service interaction between the portable device and second beacon may be carried out via a different communications mechanism (for example RF or IR), and/or according to a different communications protocol (e.g. Bluetooth, 802.11, HomeRF, Zigbee), to the exchange of inquiry message and identifier between the portable device and first beacon. The first communications protocol may suitably comprise Bluetooth messaging wherein the first beacon device is configured to broadcast a series of inquiry messages on a predetermined clocked succession of frequencies, with clock information for said first beacon device being included in data carried by said additional data field.

The system may comprise a plurality of second beacon devices, each arranged to receive identifiers from the first beacon.

To end an interaction, the identifier for a portable device may be deleted from the second beacon when the portable device again comes within the first broadcast range, or the system may further comprise a third beacon having a respective third broadcast range and coupled with the second beacon, wherein the identifier for a portable device is deleted from the second beacon when the portable device comes within the third broadcast range.

The present invention further provides a communications infrastructure for use in the communications system recited above, the infrastructure comprising first and second beacon devices and an interconnection therebetween, said beacon devices being capable of wireless message transmission to said at least one portable device, wherein said first beacon is operable to broadcast a series of inquiry messages over said first broadcast range and according to a first communications protocol, to detect any response messages containing a portable device identifier for said portable device, and to transmit a received identifier to said second beacon, and wherein said second beacon is configured to perform a service interaction with said portable device when the portable device is within said second broadcast range and triggered by the second beacon receiving the portable device identifier.

Further in accordance with the present invention there is provided a method for enabling the user of a portable communications device to perform a service interaction with a beacon device in an environment containing at least first and second beacon devices capable of wireless message transmission, wherein:

a first beacon broadcasts a series of inquiry messages over a first broadcast range and according to a first communications protocol;

the user's portable device detects such inquiry messages when within said first broadcast range and replies with an identifier for the portable device;

the first beacon device transmits a received identifier to said second beacon; and

the second beacon and portable device perform said service interaction when the portable device is within a second broadcast range of the second beacon and when triggered by the second beacon receiving the portable device identifier, with at least one of the first and second broadcast ranges being relatively short.

A plurality of different service interactions between the portable device and the second beacon may be supported, with the steps of exchanging inquiry message and identifier between the portable device and first beacon including the enabling of user selection of one or more of the available service interactions. The enabling may comprise making available to a user a menu of the different service interactions available from which menu the user selection may be made. With such a menu, the menu items may be presented sequentially with a user selecting or not selecting an item by positioning the portable device respectively within or outside the first broadcast range.

Further features and advantages of the present invention are recited in the attached claims, the disclosure of which is incorporated herein by reference, and to which the reader is now directed.

Preferred embodiments of the invention will now be described, by way of example only, and with reference to the accompanying drawings, in which:

FIG. 1 is a block schematic diagram of a beacon and portable device embodying the invention;

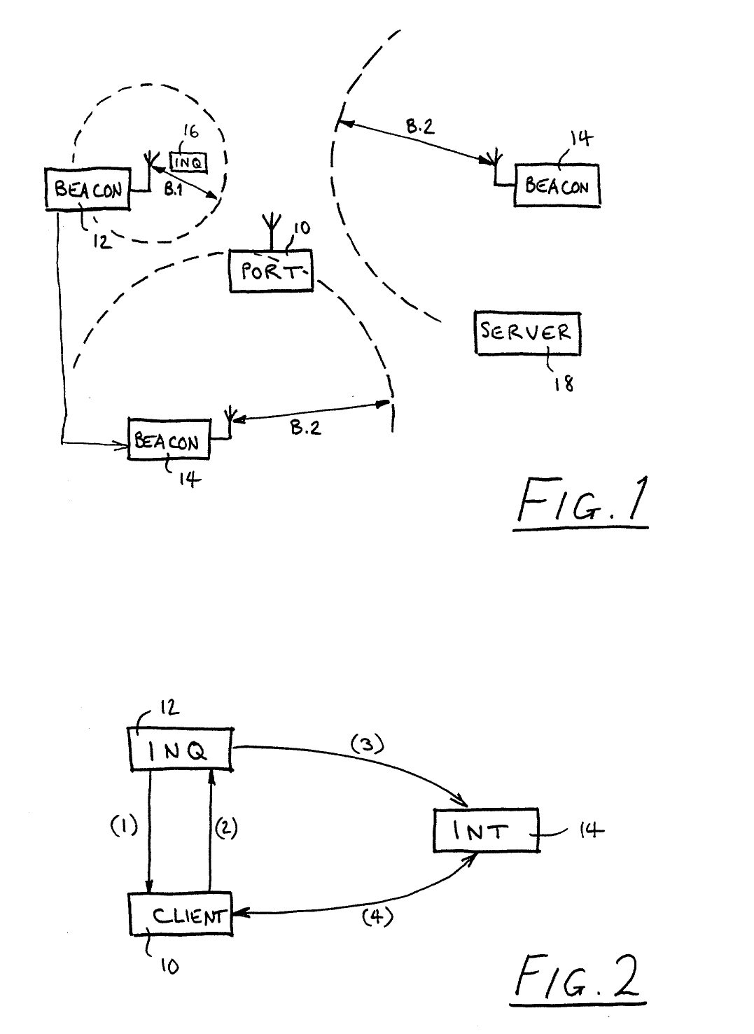

FIG. 2 is a block schematic diagram representing message establishment and hand-over in a system of multiple beacons;

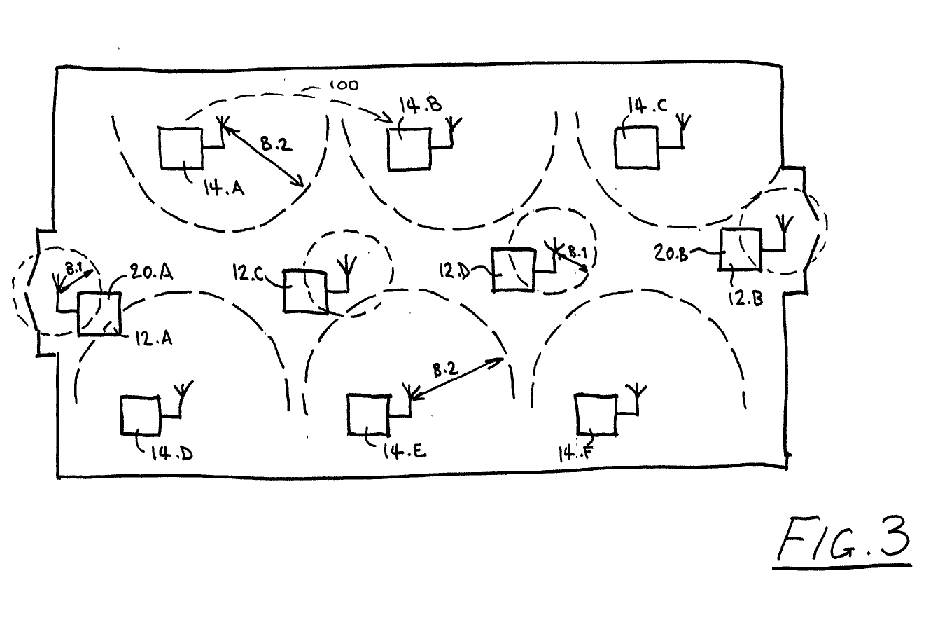

FIG. 3 schematically represents an arrangement of beacons in a shopping centre or mall;

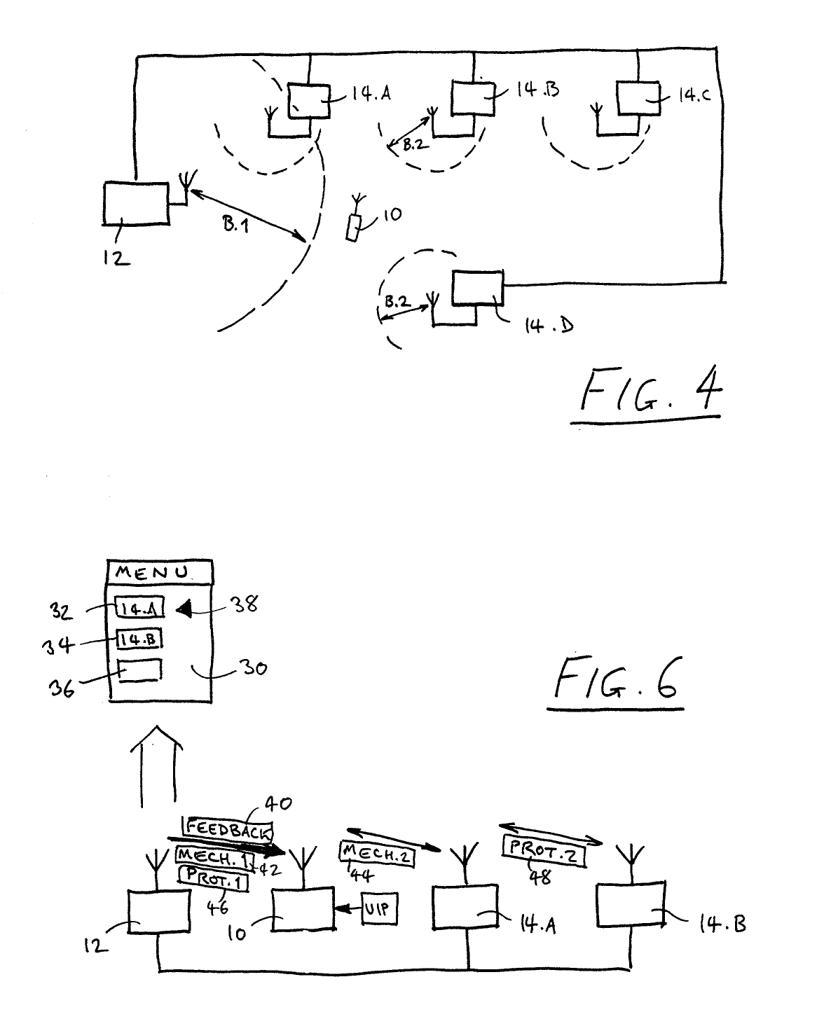

FIG. 4 is a schematic diagram of an alternative configuration of beacon infrastructure; and

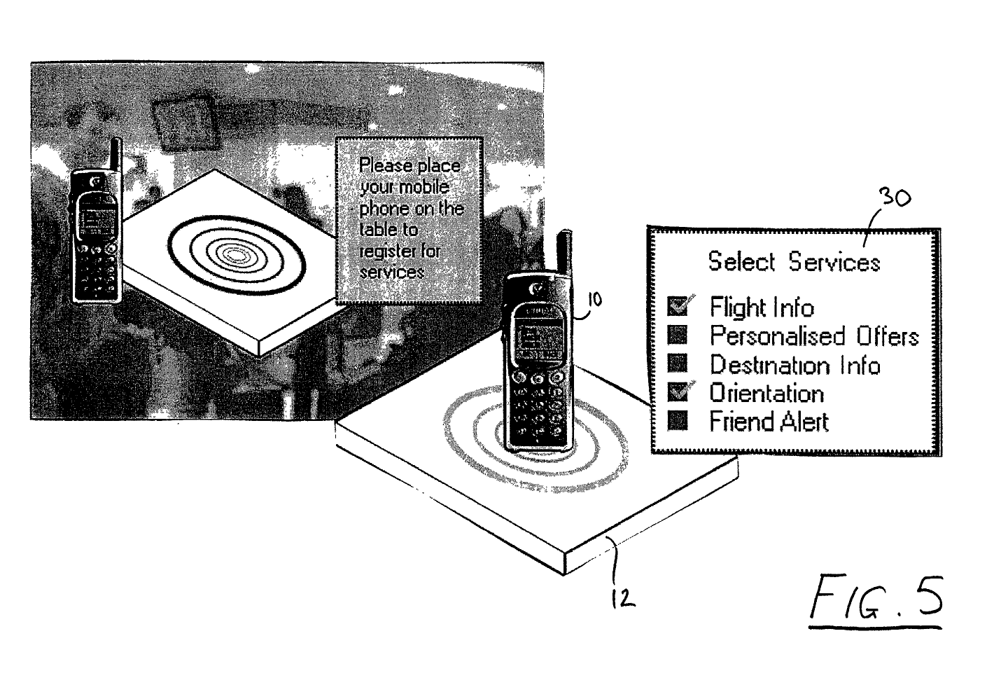

FIGS. 5 and 6 represent additional features of the embodiments of FIGS. 1 and 3.

In the following description we consider particularly a CA application which utilises Bluetooth protocols for communication of messages from beacon to portable device (whether telephone, PDA or other). As will be recognised, the invention is not restricted to Bluetooth devices, and is applicable to other communications arrangements, in particular (although not exclusively) frequency hopping systems. The detailed implementation of the system of interconnected inquirer and interactor beacons, and details of the features of a portable device co-operating with the same, are described in greater detail in the commonly-assigned and above-referenced International patent application no. EP 01/06949 entitled “Local Data Delivery Through Beacons”, the disclosure of which is incorporated herein by reference.

FIG. 1 is a block schematic diagram of a CA mobile telephone 10 in use with a pair of types of interconnected low power, short range base stations or beacons 12, 14. Such an arrangement may be used in places like shopping malls to provide location-specific information such as local maps, information on nearby shops and restaurants and so on, with a beacon downloading information keys to a mobile device. An information key is a small data object that provides a reference to a source of full information, and it is in the form of a number of predetermined fields, one of which will contain a short piece of descriptive text presented to a user. Another field will be a pointer or address of some form, for example a URL or telephone number. Other supplementary fields may control how the data is presented to a user and how the address may be exploited. A beacon will generally broadcast cyclically a number of these keys, each typically relating to a different service although, as will be recognised, waiting for the appropriate key can sometimes be a time-consuming business, and receiving unwanted keys can be unwelcome to a user.

Communication between the CA terminal (telephone 10) and the CA base stations (beacons 12 and 14) takes two forms: ‘push’ and ‘pull’. In ‘push’ mode, inquiry information is broadcast by the beacon 12 to all portable terminals 10 within range, indicated at B.1, and in the form of a short ‘key’ indicated at 16. The telephone 10, if within range, responds to the inquiry key by sending an identifier for itself to the first beacon 12, which then transfers the interaction to the second beacon 14 whilst the first continues to broadcast inquiry keys. The or each second beacon 14 has a respective broadcast range, indicated at B.2, with the broadcast ranges for the respective second beacons being separate (as shown) or overlapping.

Sometimes the user will wish to obtain more information than is contained in the keys. Here, ‘pull’ mode allows a user to set up a connection with a server 18 (which need not necessarily be specially configured for CA use) and actively request information to pull down into the terminal 10. This mode is therefore typically interactive.

As mentioned above, in the present case, one beacon 12 is labelled as an ‘inquirer’ beacon and it to sends out Bluetooth inquiry messages 16 constantly. The (or each) other beacons 14 are labelled as ‘interactor’ beacons and allowed to communicate with terminals 10 on a one-to-one basis on request. Here, the inquiry procedure is performed by an inquirer beacon 12 and the paging procedure by an interactor beacon 14. By delegating the functions this way, it is possible to save a considerable amount of time that would otherwise be lost in attempts to join piconets.

The present invention adds to the concept of the Inquirer and Interactor arrangement the concept of using a reduced-power RF or Bluetooth radio for consensual registration to receive services (information, alerts, etc.). A reduced-power Interactor or Inquirer radio requires that the mobile device 10 must be brought intentionally into close or very close range for a fixed beacon 12 to discover it (via inquiry or paging scans). This device discovery then activates the subsequent transmission of information by other Interactor radio(s) 14 to the mobile device 10. The reduced-power range B.1 may be adjustable, e.g. from very-low (cm) range (card-reader style registration), to the 1-metre range (when the natural time for registration is when passing through an entrance gate) up to 3 or even 10 metres in large scale locations. Similarly, various methods can be used for de-registration, (i.e. deleting the identifier for a portable from the Interactors 14) for example by swiping the mobile device 10 again in front of a reader (beacon 12) with reduced-power radio, detecting that the mobile device passes through an exit gate (logical or physical), use of time-outs and other techniques recited in the above-mentioned application no. EP 01/06949.

It will be appreciated that the process of a swipe to register at the first ‘inquirer’ device 12 (e.g. at an entrance door) could be synchronized for the user with a timed presentation (on a screen) of a range of broad service types. Service categories—or locales with beacons—might also be presented in a menu for subset selection on a screen (e.g. for the filling-in of chosen check boxes on a touch screen) prior to the registration ‘swipe’. The user can then be more selective about which of the available services or locales he/she consents to receiving pushed offers from. Confirmation of the success of registering the consent may be given by audible or visual feedback on the reduced-range access point, or by a signal transmitted to the mobile device (e.g. over the Bluetooth link).

For the user's selected services or service categories or beacons (and only for such selection), the user's Bluetooth device ID is passed on to the beacons involved. If those beacons are Interactor radios 14, then the interaction can be immediate (provided the portable 10 is within range B.2), using the registered Bluetooth device ID and skipping the Bluetooth inquiry process.

Alternatively, subsequently pushed signals of local information, commercial or social opportunity, once the user has consented by their Bluetooth ‘swipe’, may be delivered to the mobile not via any Bluetooth beacon, but instead via SMS, WAP or any other wide-area network (including for example 802.11). In such a case the system suitably correlates the mobiles' Bluetooth device ID's with their wide-area addresses (phone nos.), for example by pre-registration.

The split beacon technique of application divides the Bluetooth handshaking process of inquiry and paging/interaction across two radios. Either or both of these radios may deliberately have its range reduced; according to the present invention. For example:

a reduced-range swipe registration point ‘Inquirer’ Bluetooth radio 12 and one or more 10 m (or greater)-range ‘Interactor’ Bluetooth radios 14; or

a 10 m-range Inquirer radio 12 and one or more reduced-range (i.e. <5 m) Interactor radios 14. In this case, the user Bluetooth ID has already been discovered (to save time) by the Inquirer 12, and the user can subsequently collect pushed messages (or pointers to activate wide-area network delivered services) from the second Interactor beacon(s) 14 by bringing their mobile 10 into close proximity.

FIG. 2 is a block schematic of the dual beacon system illustrating (by the numbers in parentheses) the sequence of message transmission. In this basic system, there is one inquirer beacon 12 and one interactor 14, although from reading of the following it will readily be seen how the system may be expanded to a networked infrastructure of plural beacons and interactors. The inquirer beacon 12 constantly transmits inquiry packets (1), which are used to discover the identities of any clients—portable devices—in range B.1 of the beacon. Once a client 10 comes into range, it will respond to the inquiry (2), giving the inquirer information about its identity.

The information about the client discovered is then transmitted over a secure channel (typically over fixed infrastructure) to the interactor beacon 14 (3)—a beacon solely concerned with transmitting information to the client. This interactor beacon 14 then begins service interaction (4) by issuing a page message containing the client's identity to which, when the client 10 is within the second broadcast range B.2, it will respond.

Although the client is obliged to go through the inquiry and paging processes, the fact that the inquirer 12 can issue inquiry packets continuously makes the process much quicker. The use of a separate beacon 14 for all interactions means that the inquirer 12 does not have to pause to issue page messages, nor does it have to stop to allow interactive traffic. The client therefore never has to wait for the inquirer to enter inquiry mode. This in itself is a significant saving of time. As an added bonus, the interactor beacon 14 does not have to wait for an Inquiry cycle to complete before issuing a page message and some seconds can be saved here as well. As a further added bonus, by supporting consensual registration or interaction through having a shortened range for B.1 or B.2, the user can simply avoid entering interaction with services of no interest.

Multiple interactors 14 can be associated with one inquirer 12 allowing location-specific content to be sent to the client. As with the dual beacon system, the inquirer passes the identities of clients to all interactors in the network. This means that, while a client remains in range of the network, it will only ever have to go through the inquiry process once.

Once the interactors know the identities of the clients, these can then begin the task of performing the service interaction. They can all page all clients continuously. When a client walks within range B.2 of one interactor, it will respond to the page by setting up a link with that interactor. The other interactors will typically cease paging for that client until the link is cleared. More advanced paging schemes will transmit a page message only in nearby cells on the grounds that the user will have to walk through one or more of them before he can reach cells (not broadcasting the page message) located further away. In this way, large systems can page in an economical fashion. Other paging strategies are also possible, as will be readily understood by the skilled reader.

As mentioned and as illustrated in FIG. 3, more than one inquirer beacon 12.A, 12.B may be part of the system. A shopping mall might place one at each entrance to the building, for example, with respective interactor beacons 14.A-14.F for each of a number of shops. Naturally, with such a distributed system, it will not matter at which inquirer beacon 12.A or 12.B the client terminal completes the inquiry process. To provide for de-registration from the system, a third kind of beacon 20A./B may be provided at the entrances to again detect a portable device and remove its registration from the system: as will be recognised, this feature could equally well be performed by the inquirer beacons 12.A/B, simply cancelling the portable device identifier on the second, fourth, sixth, etc. times the portable comes within range B.1, having registered it on the first, third, fifth, etc. times.

Where the range B.1 of the inquirer terminals 12.A/B by the doors to the shopping centre is not so large as to cover (and detect) all portables entering the centre, a portable does not have to submit to the inquiry process as it enters the shopping mall (or other area where the beacons are located) but may hold off until such time as it discovers an interesting broadcast message, for example from additional inquirer beacons 12.C/D within the shopping centre.

Several other functions can take advantage of a distributed fixed part network. Of these, one of the most important is call hand over or handoff. This function allows a terminal, which has a link active, to transfer the link from one fixed cell 14.A to another 14.B, as represented by dashed line 100, ideally in a seamless fashion. By distributing the management of terminal identities and link functions at the fixed side, hand over in large area, multiple cell fixed networks becomes possible in Bluetooth and similar protocols.

Further features of the invention are shown in FIGS. 4, 5 and 6. In FIG. 4, the Inquirer 12 has a larger range B.1 than that of the Interactors 14, such as to capture the identifiers for all portables within range on their entry to an area, with the consensual interaction taking place through the user deciding (or not deciding) to bring the portable device 10 within the shortened range B.2 of the interactors.

FIGS. 5 and 6 show further features of the invention. To enable selection of services for interaction, the inquirer may present to the user a menu 30 of available service options 32, 34, 36 with a moving cursor 38 moving from one to another in sequence: the user can then make a selection from the menu by moving the portable device 10 within the first broadcast range B.1 when the cursor 38 is beside the desired option. The Inquirer 12 suitably provides feedback 40 to the portable 10 (or to the user via audio or visual means).

As indicated at 42 and 44, the communications between the portable 10 and the Inquirer beacon 12 may utilise a different mechanism to that between the portable 10 and an Interactor 14.A. Alternatively, the communications between portable 10 and Inquirer 12 may follow different communications protocols 46, 48 to that between portable 10 and Interactor 14.B

In the foregoing, we have provided a communications system comprising first and second beacon devices capable of wireless message transmission and at least one portable device capable of receiving such message transmissions. The first beacon is arranged to broadcast a series of inquiry messages over a first broadcast range and according to a first communications protocol, such as Bluetooth. The portable device detects such inquiry messages and replies with an identifier for the portable device. The first beacon then transmits the received identifier to the second beacon, with the second beacon and portable device configured to perform a service interaction when the portable device is within a respective second broadcast range of the second beacon and when triggered by the second beacon receiving the portable device identifier. At least one of the first and second broadcast ranges is relatively short, such as to permit interaction only when the user places the portable device within the respective broadcast range.

The main advantages are the natural simplicity and transparency of this physical opt-in consent action for the user, with its added security and privacy benefits. The user knows their openness to push is bounded, both geographically as well as by service offer category and possibly time. Savings can also be made on the system side in stopping unwanted offer generation, with the corresponding reduction of wasted radio spectrum usage. The technique also reduces the need for coarse filtering on the handset of the pushed alerts in certain locations or of unwanted service types, at least when in closed environments which support this technique for registration.

From reading the present disclosure, other modifications will be apparent to persons skilled in the art. Such modifications may involve other features which are already known in the design, manufacture and use of fixed and portable communications systems, and systems and components for incorporation therein and which may be used instead of or in addition to features already described herein.

1. A communications system comprising first and second beacon devices capable of wireless message transmission and at least one portable device capable of receiving such message transmissions, wherein said first beacon is arranged to broadcast a series of inquiry messages over a first broadcast range and according to a first communications protocol, wherein said at least one portable device is arranged to detect such inquiry messages when within said first broadcast range and reply with an identifier for the portable device, wherein said first beacon device is arranged to transmit a received identifier to said second beacon, wherein said second beacon and portable device are configured to perform a service interaction when the portable device is within a second broadcast range of the second beacon and when triggered by the second beacon receiving the portable device identifier, and wherein at least one of the first and second broadcast ranges is a relatively short broadcast range.

2. A system as claimed in claim 1, wherein said relatively short broadcast range is such as to require a user of the portable communications device to place said device deliberately relative to the position of the first and/or second beacon to enable interaction.

3. A system as claimed in claim 1, wherein said relatively short broadcast range is of the order of 10 metres or less.

4. A system as claimed in claim 1, wherein said relatively short broadcast range is of the order of 3 metres or less.

5. A system as claimed in claim 1, wherein said relatively short broadcast range is of the order of 1 metre or less.

6. A system as claimed in claim 1, wherein said first broadcast range is relatively short in comparison with said second broadcast range.

7. A system as claimed in claim 1, wherein said second broadcast range is relatively short in comparison with said first broadcast range.

8. A system as claimed in claim 1, wherein the broadcast range from the, or one of the, first and second beacons having a relatively short broadcast range is adjustable.

9. A system as claimed in claim 1, wherein the exchange of inquiry message and identifier between the first beacon and portable device includes specification of one or more service interaction types, wherein plural forms of service interaction between said second beacon device and portable device are supported, and wherein one or more of said plural form is inhibited in dependence on said included specification of one or more service interaction types.

10. A system as claimed in claim 1, wherein said first beacon is arranged, on receipt of an identifier for a portable device, to provide an indication to the user of the portable device that said device is registered for interaction with said second beacon.

11. A system as claimed in claim 10, wherein said indication comprises an audible signal.

12. A system as claimed in claim 10, wherein said indication comprises an visual signal.

13. A system as claimed in claim 10, wherein said indication comprises a confirmatory signal transmitted from said first beacon to said portable device.

14. A system as claimed in claim 1, wherein said service interaction between said portable device and said second beacon is carried out via a different communications mechanism to the exchange of inquiry message and identifier between said portable device and said first beacon.

15. A system as claimed in claim 1, wherein said service interaction between said portable device and said second beacon is carried out according to a different communications protocol than that according to which the exchange of inquiry message and identifier between said portable device and said first beacon is carried out.

16. A system as claimed in claim 1, comprising a plurality of second beacon devices, each arranged to receive identifiers from the first beacon.

17. A system as claimed in claim 1, wherein said first communications protocol comprises Bluetooth messaging wherein the first beacon device is configured to broadcast a series of inquiry messages on a predetermined clocked succession of frequencies, with clock information for said first beacon device being included in data carried by said additional data field.

18. A system as claimed in claim 1, wherein the identifier for a portable device is deleted from the second beacon when the portable device again comes within said first broadcast range.

19. A system as claimed in claim 1, further comprising a third beacon having a respective third broadcast range and being coupled with said second beacon, wherein the identifier for a portable device is deleted from the second beacon when the portable device comes within said third broadcast range.

20. A communications infrastructure for use in the communications system of claim 1, the infrastructure comprising first and second beacon devices and an interconnection therebetween, said beacon devices being capable of wireless message transmission to said at least one portable device, wherein said first beacon is operable to broadcast a series of inquiry messages over said first broadcast range and according to a first communications protocol, to detect any response messages containing a portable device identifier for said portable device, and to transmit a received identifier to said second beacon, and wherein said second beacon is configured to perform a service interaction with said portable device when the portable device is within said second broadcast range and triggered by the second beacon receiving the portable device identifier.

21. A communications infrastructure as claimed in claim 20, further comprising a plurality of second beacons.

22. A communications infrastructure as claimed in claim 21, further comprising message management means operable to initiate and effect handover of an ongoing message transmission session from one of said plurality of beacons to another.

23. A communications infrastructure as claimed in claim 20, further comprising a plurality of said first beacon devices.

24. A method for enabling the user of a portable communications device to perform a service interaction with a beacon device in an environment containing at least first and second beacon devices capable of wireless message transmission, wherein:
a first beacon broadcasts a series of inquiry messages over a first broadcast range and according to a first communications protocol;
the user's portable device detects such inquiry messages when within said first broadcast range and replies with an identifier for the portable device;
the first beacon device transmits a received identifier to said second beacon; and
the second beacon and portable device perform said service interaction when the portable device is within a second broadcast range of the second beacon and when triggered by the second beacon receiving the portable device identifier, with at least one of the first and second broadcast ranges being relatively short.

25. A method as claimed in claim 24, wherein the second beacon device maintains and periodically updates a list of identifiers for portable devices with which a service interaction is being performed.

26. A method as claimed in claim 24, wherein a plurality of different service interactions between the portable device and the second beacon are supported, and the steps of exchanging inquiry message and identifier between the portable device and first beacon include enabling user selection of one or more of said service interactions.

27. A method as claimed in claim 26, further comprising the step of making available to a user a menu of the different service interactions available from which menu the user selection may be made.

28. A method as claimed in claim 27, wherein the menu items are presented sequentially and a user selects or does not select an item by positioning the portable device respectively within or outside said first broadcast range.

29. A method as claimed in claim 27, further comprising the step of providing feedback to a user to confirm selection of items from the menu.
